(19) United States
(12) Patent Application Publication
(10) Pub. No.: US 2008/0141775 A1
(43) Pub. Date: Jun. 19, 2008

(54) Diagnostic method for a final control element driven by auxiliary power

(75) Inventors: Detlef Pape, Nussbaumen (CH); Andreas Stelter, Minden (DE); Frank Marks, Dusseldorf (DE); Urs E. Meier, Wurenlingen (CH)

Correspondence Address: BUCHANAN, INGERSOLL & ROONEY PC, POST OFFICE BOX 1404, ALEXANDRIA, VA, 22313-1404, US

(73) Assignee: ABB Patent GmbH, Ladenburg (DE)

(21) Appl. No.: 11/980,399

(22) Filed: Oct. 31, 2007

(30) Foreign Application Priority Data
Dec. 19, 2006 (DE) 10 2006 059 938.1

(51) Int. Cl. G01N 29/14

(52) U.S. Cl. 73/587

(57) ABSTRACT

The invention relates to a diagnostic method for a final control element (2) driven by auxiliary power, in which the auxiliary power is supplied by means of an actuator for converting an electrical manipulated variable into a physical variable of the auxiliary power, where the elements of the actuator form a control loop. It is proposed to operate the actuator as a sensor in a direction of action of the signal flow that is opposite to its conventional direction.

The invention relates to a diagnostic method for a final control element driven by auxiliary power according to the features of the preamble of claim 1.

Control valves, as the type of final control elements in question, are generally known in automation and process engineering as extremely important elements in the control and regulation of processes. Their reliability is a crucial factor in the quality of the overall control process. Faults occurring during operation can result in failure of the entire system, with high maintenance costs as a consequence. Hence early diagnosis and thereby detection of faults in the valve can prevent such failures, and consequently also reduce the costs that arise from replacing, as a precaution, valves that are still working perfectly.

In particular, leaks from valves in the closed state are of significant diagnostic interest. The sealing action of the valve seating is reduced by ageing processes or dirt accumulation, and the process medium continues to flow through the valve despite a closed valve being signaled to the outer world.

Such leaks can be detected, for example, by a flow-rate sensor connected downstream that is installed additionally in the process line. Such a sensor is very expensive, however, and there is a high cost involved in fitting the sensor. In addition, the power consumption of the flow-rate sensor is normally so high that it cannot share the supply for the valve controller, but requires an additional supply line. Thus such a sensor is normally only installed when it is already required for the process control system. In addition, it is known from the dissertation of Sebastian Maria Mundry “Zustandsüberwachung an Prozessventilen mit intelligenten Stellungsreglern” [“Monitoring the status of process valves using intelligent positioners”], Shaker Verlag, Aachen, 2002, that flow-rate sensors for measuring the maximum flow rate are not suitable for reliable detection of the low flow rates from leaks.

It is also known from the same publication that the flow of a fluid under pressure through a narrow aperture produces an acoustic signal as a result of various physical effects. For instance, the high flow rates that arise cause severe turbulence after the aperture, and the pressure drop in the flow results in cavitation. The turbulence and the collapse of the cavitation bubbles produce an acoustic signal that is directly dependent on the flow rate and the fluid properties. At low rates, the signal is composed of individual acoustic pulses generated by the collapse of the individual cavitation bubbles, and develops into white noise at high rates. This acoustic signal is overlaid by the general process sounds in the plant, which are produced by pumps, general flow noises, chemical processes etc.

As these process sounds propagate in the pipeline system of the plant, the sounds are attenuated by different amounts depending on their frequency. The high frequencies, in particular, are strongly attenuated, so that generally process noises are only detectable at the valve as low-frequency acoustic signals (in the kHz range). Thus the sounds produced by the leak can be discriminated from the general process sounds by measuring in higher frequency ranges. It is known from Leak Detection Service, Maintaining a Successful Valve and Trap Leak Detection Program using the Valve-Analyser System, The 10th Annual Predictive Maintenance Technology National Conference, Nov. 9-12, 1998, that valve service companies currently use ultrasound sensors in order to measure the acoustic signals directly at the valve, i.e. close to the noise source. In addition, these signals are also compared with the signals from ultrasound sensors installed further upstream and downstream in the pipeline system. A leak can then be detected from these signals, and, with suitable calibration, it is even possible to determine the size of the leak for the valve from the signal level.

Furthermore, EP 1216375 B1 and WO 00/73688 A1 disclose detecting the structure-borne noise on the valve casing or on parts directly connected to this, and supplying this information to the positioner, in which it is evaluated and processed. The valve is continuously monitored, with the electronics and position signal already available in the positioner being shared for the diagnosis. The publications also disclose that high-frequency signals (>50 kHz) are analyzed, and that the ultrasound spectrum in the closed state is compared with a signal in the slightly open state. The latter methods can be applied equally well to reducing the ambient noise without comparative measurements needing to be made at different points in the direction of flow and against the direction of flow. Although sharing the use of the position-sensor electronics and the position signal does reduce the installation costs for this diagnostic system, the ultrasound sensor head itself must still be fitted on the valve as an additional external unit.

Hence the object of the invention is to record significant status signals of the final control element to be monitored, at minimum possible expense and under continued use of the existing means necessary for the conventional use of the final control element.

This object is achieved according to the invention by the means of claim 1. Advantageous embodiments of the invention are given in the dependent claims.

The invention is based on a final control element driven by auxiliary power, in which the auxiliary power is supplied by means of an actuator for converting an electrical manipulated variable into a physical variable of the auxiliary power, where the elements of the actuator form a control loop.

According to the invention, the actuator, in detecting status signals from the final control element, is operated as a sensor in a direction of action of the signal flow that is opposite to its conventional direction. Here, the perturbing effect of the final control element on an element in the control loop of the actuator is detected, selected and evaluated as a disturbance variable. In detail, a mixed signal composed of the actual signal from the actuator and status signals from the final control element is picked up at the signal-receiving control-loop element.

Advantageously, by using the actuator, which is present for conventional purposes, as a sensor for the perturbing effect of the final control element, it is possible to dispense with additional control elements and components for signal detection.

According to another feature of the invention, the sensor signal is derived from the control deviation of the actuator. In this case, the mixed signal that can be picked up at the signal-receiving control-loop element is advantageously separated from the stationary component of the actual signal from the actuator, except for the control deviation.

According to another feature of the invention, the sensor signal is derived from the control variable of the actuator. In this case, the sensor signal is separated from the stationary component of the actual signal from the actuator by filtering higher frequency signal components.

The invention is described in more detail below with reference to an exemplary embodiment and the requisite drawings, in which

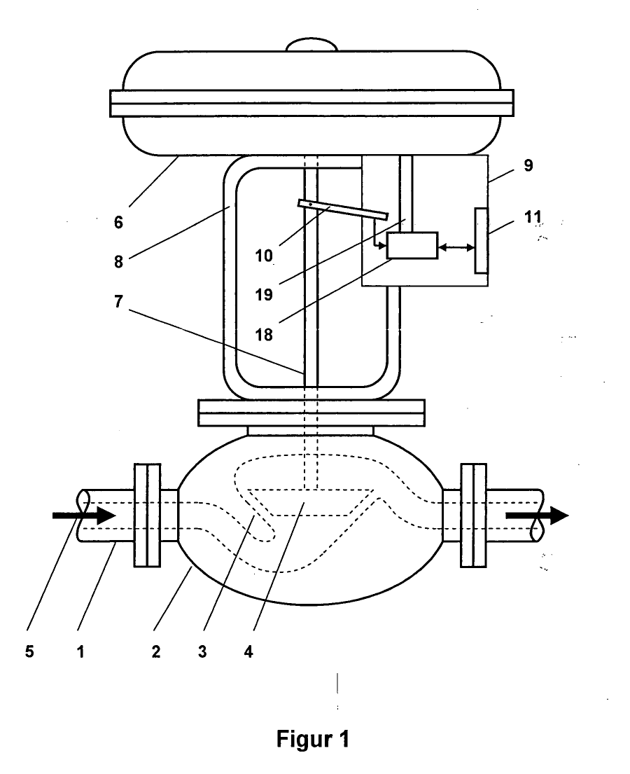

FIG. 1 shows a schematic diagram of a pneumatically operated actuating mechanism having a process valve

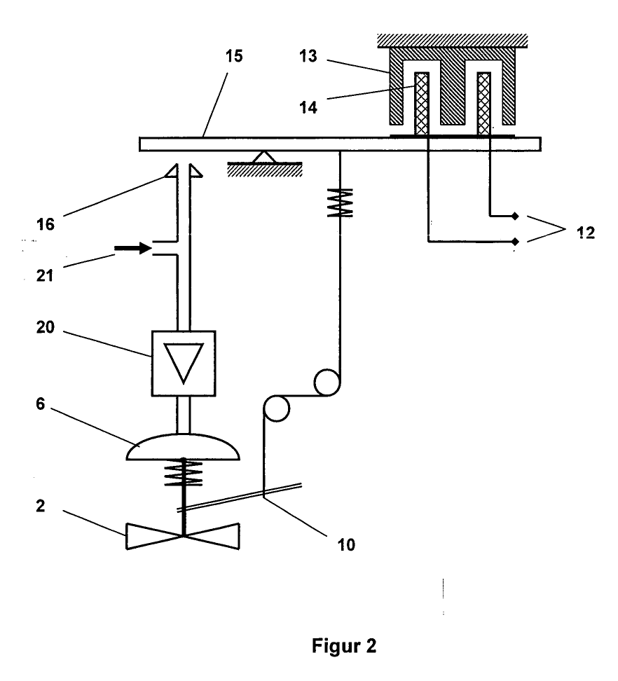

FIG. 2 shows a schematic diagram of a positioner based on the jet/baffle-plate principle

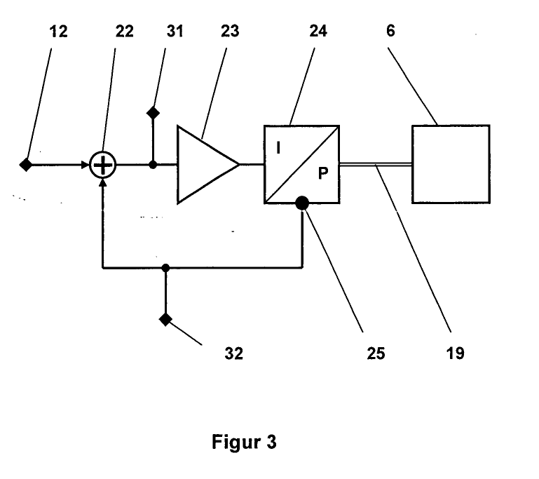

FIG. 3 shows a schematic diagram of a controlled I/P converter.

FIG. 1 shows a process valve 2 installed in a section of a pipeline 1, which is part of a process plant (not shown further). Inside the process valve 2 there is a closing body 4 that interacts with a valve seating 3 in order to control the quantity of process medium 5 passing through. The closing body 4 is operated linearly by an actuating mechanism 6 via a rod 7. The actuating mechanism 6 is connected to the process valve 2 via a yoke 8. A positioner 9 is mounted on the yoke 8. The travel of the rod 7 into the positioner 9 is signaled via a position sensor 10. The detected travel is compared in a control unit 18 with the setpoint value supplied via a communications interface 11, and the actuating mechanism 6 is controlled as a function of the detected control deviation. The control unit 18 of the positioner 9 comprises an I/P converter for converting an electrical control deviation into an appropriate control pressure. The I/P converter of the control unit 18 is connected to the actuating mechanism 6 via a pneumatic-fluid supply line 19.

In a first embodiment of the invention, the positioner 9 is designed on the basis of the jet/baffle-plate principle known per se. As shown in FIG. 2, this principle is based on a force balance, in which a balance beam 15 is held in equilibrium by the force of an electromagnet comprising an induction cup 13, into which a plunge coil 14 extends, on one side, and by the flow through a jet 16, for which the balance beam 15 is designed as a baffle plate, on the other side. The plunge coil 14 of the electromagnet is supplied with a current equivalent to the setpoint value via the terminals 12. When the current increases, the plunge coil 14 is pulled deeper into the induction cup 13, and the jet 16 under the baffle plate is thereby closed slightly more. This results in an increase in pressure on the pneumatic-fluid supply line 21, which is transferred to the actuating mechanism 6 via the pneumatic amplifier 20. The process valve 2 is adjusted according to the change in setpoint value. The position of the process valve 2 is fed back to the balance beam 15 via the position sensor 10. The balance beam thereby returns to equilibrium.

During conventional use, vibrations are excited in the process valve 2 as a function of its operating status. The excitations can have various causes as mentioned in the introduction, and result in acoustic signals appearing in different frequency ranges. For instance, acoustic signals in the region of several kilohertz indicate a leak, whereas low-frequency acoustic signals point to vibrations of the process valve 2.

These acoustic signals propagate in the process valve 2 and are fed back into the pneumatic system of the actuating mechanism 6 via the elements directly connected to the process valve 2. In this case, the acoustic signals are mainly transferred via the valve rod 7 onto the membrane in the actuating mechanism 6 and into the housing of the actuating mechanism 6, which amplify these signals like a large loudspeaker membrane and transfer them to the pneumatic fluid. Inside the actuating mechanism 6, in particular, strong amplification of the acoustic signal takes place in the pneumatic fluid of the drive chamber.

The acoustic signals also propagate via the pneumatic amplifier 20 into the pneumatic-fluid supply line 19 and the jet 16. The fluctuations in pressure in the pneumatic system caused by these signals produce a mechanical vibration of the balance beam 15 via the jet/baffle-plate system, which propagates into the plunge coil 14, which enters and re-emerges from the induction cups 13 tracking the vibration. An alternating magnetic field is generated in the electromagnet in the process, which induces an alternating voltage in the plunge coil 14, which, superimposed on the current equivalent to the setpoint value, can be picked up at the terminals 12 and can be provided for analytical processing. This means that additional sensors can be dispensed with. Thus leak detection can be implemented as a pure software solution in the positioner 9.

In addition to leak detection, it is also possible to use the procedure described above to evaluate and analyze sounds other than the flow sounds described above. These include particularly, but not exclusively, vibrations of the process valve 2, leaks in the drive system in the actuating mechanism 6 or in its supply lines, which, similarly to leaks in the process valve 2, can become perceptible as sounds in the pneumatic fluid, or other fault sources, which a technician would currently identify on-site by listening. It can be provided in this case to process these additional sounds by suitable acoustic analysis in the device or by transferring the sounds to a central device where they can be analyzed by a technician, without the technician needing to go to the site of the process valve 2. Whenever a strong, unusual sound arises, for example at the process valve 2, this can be transferred to the central device in the form of an acoustic file for diagnosis. Both manual and automated analysis of the received acoustic file can be provided in the central device.

According to a further feature of the invention, it is provided that the status data of the final control element is derived from the amplitude spectrum of the fed back acoustic signals. In this case, the occurrence of characteristic spectral images is used to infer associated status conditions of the final control element.

According to an alternative feature of the invention, it is provided that the status data of the final control element is derived from the levels of the fed back acoustic signals. This feature is based on the knowledge that the status of the final control element can already be inferred just from the intensity of the fed back acoustic signal.

According to another alternative feature of the invention, it is provided that the status data of the final control element is derived from characteristic patterns of the fed back acoustic signals. This is based on the knowledge that certain status conditions of the final control element can be assigned a respective characteristic acoustic pattern, which when identified in the fed back acoustic signal indicates the respective status.

In addition, in order to specify the diagnosis more precisely, the current status of the final control element and/or actuating mechanism can be used, for instance whether the process valve 2 is in the open or closed position, auxiliary power present/not present. This current status can be derived, for example, from the setpoint/actual signals or from general information about the system.

In a second embodiment of the invention, as shown in FIG. 3, where the same reference numbers are used for the same means, the positioner 9 comprises an I/P converter 24 of any design inside a cascaded control loop, whose control pressure is regulated against an electrical voltage equivalent to a setpoint pressure, said voltage being provided at the terminal 12. For this purpose, a pressure sensor 25 is arranged on the pneumatic side of the I/P converter 24, whose electrical output signal, summed with the electrical voltage 22 equivalent to the setpoint pressure, is connected to a control amplifier 23. The output of the control amplifier 23 is connected to the electrical input of the I/P converter 24.

During conventional use, an electrical signal is provided by the control amplifier 23 so that the control pressure on the pneumatic side of the I/P converter 24 equals the defined setpoint pressure. The pressure-regulated I/P converter 24 is thereby an actuator, which is a control-loop element in the control loop for positioning the actuating mechanism 6 for the process valve 2.

The acoustic signals emanating from the process valve 2 are fed back into the pneumatic system in amplified form as already described above, and propagate in the pneumatic system. In the process, pressure fluctuations at the pressure sensor 25 of the pressure-regulated I/P converter 24 are converted into an appropriate electrical alternating quantity.

In one embodiment of the invention, the alternating quantity is derived at the point labeled with reference number 31 in the control circuit from the control variable of the pressure-regulated I/P converter 24. In this case, the sensor signal is separated from the stationary component of the actual signal from the pressure-regulated I/P converter 24 by filtering higher frequency signal components.

In an alternative embodiment of the invention, the alternating quantity is derived at the point labeled with reference number 32 in the control circuit from the control deviation of the pressure-regulated I/P converter 24. In this case, the mixed signal that can be picked up at the signal-receiving control-loop element is advantageously separated from the stationary component of the actual signal from the pressure-regulated I/P converter 24, except for the control deviation.

Both embodiments share the feature that an existing control-loop element is used for another purpose. The pressure sensor 25 is already a component of the pressure-regulated I/P converter 24 already known, and is used to regulate the control pressure for the actuating mechanism 6.

### LIST OF REFERENCES

1 pipeline

2 process valve

3 valve seating

4 closing body

5 process medium

6 actuating mechanism

7 valve rod

8 yoke

9 positioner

10 position sensor

11 communications interface

12 terminal

13 induction cup

14 plunge coil

15 balance beam

16 jet

17 storage device

18 control unit

19, 21 pneumatic-fluid supply line

20 pneumatic amplifier

22 summation

23 control amplifier

24 I/P converter

25 pressure sensor

31, 32 signal pick-up

1. A diagnostic method for a final control element and/or actuating mechanism driven by auxiliary power, in which the auxiliary power is supplied by means of an actuator for converting an electrical manipulated variable into a physical variable of the auxiliary power, where the elements of the actuator form a control loop, wherein the actuator is operated as a sensor in a direction of action of the signal flow that is opposite to its conventional direction.

2. The method as claimed in claim 1, wherein the sensor signal is derived from the control deviation of the actuator.

3. The method as claimed in claim 1, wherein the sensor signal is derived from the control variable of the actuator.

4. The method as claimed in claim 1, wherein the status data of the final control element is derived from the amplitude spectrum of the fed back acoustic signals.

5. The method as claimed in claim 1, wherein the status data of the final control element is derived from the levels of the fed back acoustic signals.

6. The method as claimed in claim 1, wherein the status data of the final control element is derived from characteristic patterns of the fed back acoustic signals.
